(19) United States
(12) Patent Application Publication
(10) Pub. No.: US 2006/0168108 A1
(43) Pub. Date: Jul. 27, 2006

(54) Methods and systems for defragmenting subnet space within an adaptive infrastructure

(76) Inventors: Mike Hake, Fort Collins, CO (US); Samuel L. Scarpello, Windsor, CO (US); Carlos Bonilla, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/986,946

(22) Filed: Nov. 12, 2004

(51) Int. Cl. G06F 15/16; G06F 15/173

(52) U.S. Cl. 709/218; 709/223

(57) ABSTRACT

Methods and systems for defragmenting subnet space within an adaptive infrastructure are disclosed. A method includes defining parameters of a netmask that is used to determine if subnets are joinable, identifying subnets to include in a list of available subnets that identifies subnets that are available to be allocated to resources that are a part of an adaptive infrastructure, comparing each subnet in the list of available subnets with every other subnet in the list of available subnets to determine if each subnet in the list of available subnets is joinable with any other subnet in the list of available subnets. The method further includes deleting a subnet from the list of available subnets if the subnet is determined to be joinable with another subnet in the list of available subnets and replacing deleted individual subnets that are joinable together with supernets of the deleted individual subnets that are joinable together.

### TECHNICAL FIELD

Embodiments of the present invention relate to methods and systems for defragmenting subnet space within an adaptive infrastructure.

### BACKGROUND ART

Fast paced change is a staple of today's business environment. Successful organizations rely on their capacity to quickly deliver services to market in order to meet customer demands. This is particularly true in the information technology (IT) arena.

One approach that has been suggested as a means of responding to volatile business demands in the IT arena is the use of adaptive infrastructures. Adaptive infrastructures allow IT organizations to provision the amount of resources that a service requires so that over and under provisioning of resources is eliminated. It should be appreciated that provisioned resources are allocated blocks of subnet space (e.g., address space allocated to a portion of a network that shares a common address component). However, as managed resources are moved around in the infrastructure where resources are allocated and then returned to a resource pool, the available subnet space becomes fragmented.

One of the many resources being managed in an adaptive infrastructure is the available subnet space. The subnet space allocated to the infrastructure is available for use in adaptive infrastructures in the dynamic creation of multi-tier network architectures for use by customers.

The subnet space allocated to the infrastructure will start out as large contiguous blocks of internet protocol (IP) addresses. For example, the infrastructure may be allocated entire class A, B, or C subnets, then as smaller subnets are needed within the infrastructure, these large subnets are split up as necessary.

As resources are moved around within the infrastructure, subnets that are no longer needed are returned to the resource pool. Over time the subnet space available in the resource pool can become quite fragmented. What started out as a class C subnet, with 255 available addresses, may after fragmentation encompass several /28 subnets, each with only 16 available addresses. If a request comes along that requires more space than is encompassed by a /28 subnet, several smaller subnets must first be joined. Accordingly, a system that solves the problem of fragmented subnet space is needed.

### DISCLOSURE OF THE INVENTION

Methods and systems for defragmenting subnet space within an adaptive infrastructure are disclosed. A method includes defining parameters of a netmask that is used to determine if subnets are joinable, identifying subnets to include in a list of available subnets that identifies subnets that are available to be allocated to resources that are a part of an adaptive infrastructure and comparing each subnet in the list of available subnets with every other subnet in the list of available subnets to determine if each subnet in the list of available subnets is joinable with any other subnet in the list of available subnets. The method further includes deleting a subnet from the list of available subnets if the subnet is determined to be joinable with another subnet in the list of available subnets and replacing deleted individual subnets that are joinable together with supernets of the deleted individual subnets that are joinable together.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a utility data center (UDC) that includes a system for defragmenting subnet space according to one embodiment of the present invention.

FIG. 2 shows a system for defragmenting subnet space within an adaptive infrastructure according to one embodiment of the present invention.

FIG. 3 shows a flowchart of the steps performed in a method for defragmenting subnet space according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

It should be appreciated that in the present embodiment a “subnet” is intended to refer to a portion of a network that shares a common address component. Moreover, “subnet space” is intended to refer to address space allocated to a portion of a network that shares a common subnet component.

### Exemplary Network Context for System for Defragmenting Subnet Space According to One Embodiment of the Invention

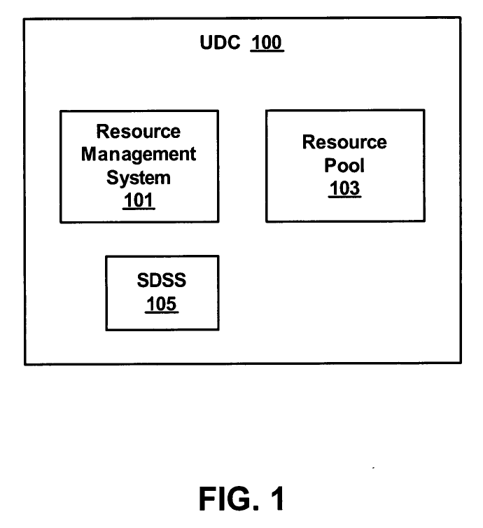

FIG. 1 shows a utility data center (UDC) 100 that includes a system for defragmenting subnet space (SDSS) 105 according to one embodiment of the present invention. In the present embodiment, UDC 100 virtualizes network resources (e.g., makes network resources available to a plurality of requesters based on the availability of the resource) and automates the management of these resources. It should be appreciated that as subnet space for the network resources is allocated and redeployed as a part of resource management operations, the subnet space that is available can become quite fragmented (formerly contiguous blocks of space can be separated). System for defragmenting subnet space 105 defragments subnet space by automatically joining adjacent subnet Internet Protocol (IP) addresses that are returned to the resource pool 103 when they are no longer in use. In the FIG. 1 embodiment, UDC 100 includes resource management system 101, resource pool 103, and system for defragmenting subnet space (SDSS) 105.

Resource management system 101 receives requests (e.g., service demands) from users and logically assigns resources in response to the requests. In one embodiment, resources are virtualized (e.g., resources can be allocated and then reallocated to respective users as is required by the user's service needs). In this embodiment, as the demand for the various services that are offered rises and falls during daily operations, the resource management system 101 automatically allocates and redeploys available resources as a means of efficiently keeping pace with business needs.

Resource pool 103 includes the pool of resources that are available via the utility data center (UDC) 100. Resources can include but are not limited to computers, applications, disk space, servers, and subnet IP addresses. As discussed above, the resources that are included in the resource pool can be automatically allocated and redeployed as a means of keeping pace with business needs.

System for defragmenting subnet space 105 defragments subnet space by joining adjacent subnet IP addresses that are returned to the resource pool 103 when they are no longer in use. In one embodiment, these operations are wholly automated. In another embodiment, these operations are partly automated and partly manually provided. In one embodiment, components and operations embodied by system for defragmenting subnet space 105 can be encompassed by components and operations associated with the UDC 100. In another embodiment, components and operations embodied by system for defragmenting subnet space 105 can be separate from but operate in cooperation with components and operations of the UDC 100.

In operation, when requests for resources are received that require subnet space, resource management system 101 allocates resources as is discussed above. It should be appreciated that as resources are moved around in the infrastructure (e.g., such as to accommodate the resource demands received from different customers), subnets that are no longer needed are returned to resource pool 103. Through this process, and over a period of time, the subnet space that is available in the resource pool 103 can become fragmented. For example, resource pool 103 can initially include a class C subnet, with 255 available addresses, but after the fragmentation that can result from the allocation and subsequent redeployment of subnet space, may include only several /28 subnets, that each merely provide 16 available addresses. In the present embodiment, system for defragmenting subnet space 105 can defragment the fragmented subnet space by joining adjacent subnet IP addresses that are returned to the resource pool 103 when they are no longer in use. Consequently, demands for subnet space resources that exceed that which can be accommodated by /28 subnets can be accommodated by the defragmented subnet space provided by the system for defragmenting subnet space 105 of exemplary embodiments.

It should be appreciated that the fragmentation problem discussed above arises as a consequence of the allocation and de-allocation of subnet space of the adaptive infrastructure of the UDC 100. In previous applications of the UDC 100 there was no automation provided to defragment subnet space. In such previous applications, when the subnet space became fragmented, an operator that was experienced in the rules for joining subnets would have to manually remove subnets from the UDC 100, and then add the larger supernets. It should be appreciated that this process was both error prone and time consuming.

### Exemplary System for Defragmenting Subnet Space According to One Embodiment of the Invention

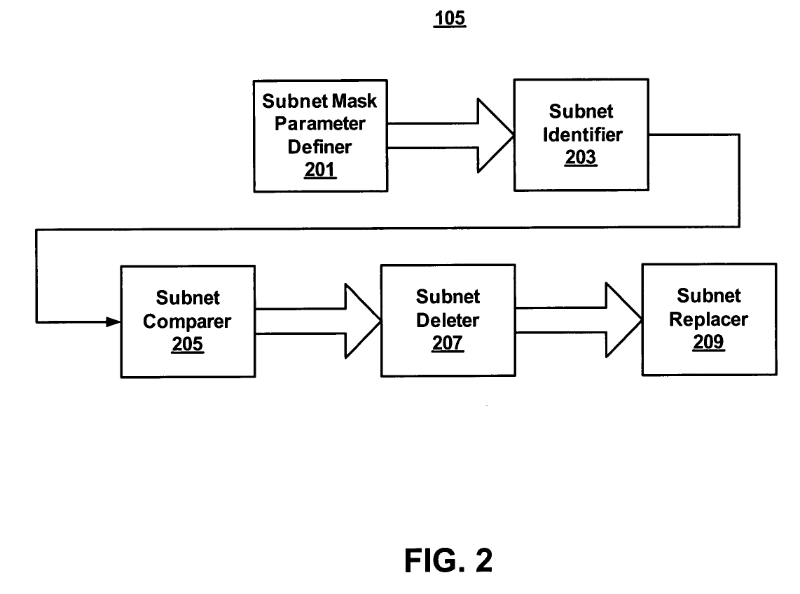

FIG. 2 shows a system for defragmenting subnet space 105 within an adaptive infrastructure according to one embodiment of the present invention. System for defragmenting subnet space 105 defragments subnet space by joining adjacent subnet IP addresses that are returned to a resource pool (e.g., 103 in FIG. 1) when they are no longer in use. FIG. 2 shows various components that are encompassed by the system for deframenting subnet space 105 according to one embodiment of the present invention. FIG. 2 shows subnet mask parameter definer 201, subnet identifier 203, subnet comparer 205, subnet deleter 207 and subnet replacer 209.

Subnet mask parameter definer 201 defines the parameters of a subnet mask that is used to determine if subnets are joinable. In the present embodiment, parameters of the subnet mask that is used to determine if subnets are joinable may be defined by a network administrator or may be defined through automation. The parameters of the subnet mask that is used to determine if subnets are joinable may be defined based on factors that may include but are not limited to analysis of available subnet space and the specifics of the request that is made for subnet space.

The following example illustrates the role that the definition of parameters of a subnet mask by the subnet mask parameter definer 201 plays in the defragmenting of subnet space, and will be referred to in the discussion of the other components of the system for defragmenting subnet space 105.

In the present embodiment a subnet mask is intended to refer to the network address portion of an IP address plus the bits reserved to identify the subnets to which the subnet mask corresponds. As an example, consider the following subnet address:

16.0.0.0/28

This subnet address may be represented in binary format by the following four octet series of bits:

0001 0000.00000000.00000000.00000000

The subnet mask for the above IP address is given by:

11111111.11111111.11111111.11110000

wherein the first three octets represent the network address portion of the subnet mask and the first four bits of the fourth octet are reserved to identify the subnets to which the subnet mask corresponds. The above subnet mask has 28 consecutive bits that are represented by a “1” and is thus termed a /28 subnet.

Consider the case where subnet mask parameter definer 201 dictates that each subnet to be combined: (1) has the same subnet mask and that (2) the subnet mask is defined as netmask=netmask−1 (it should be appreciated that where the new netmask is applied to each of the subnets, the resulting network portion of each subnet is identical).

Moreover, assume that the list of available subnets includes the following four /28 subnets:

| | |
|---|---|
| 16.0.0.0/28 | 00010000.00000000.00000000.00000000 |
| 16.0.0.16/28 | 00010000.00000000.00000000.00010000 |
| 16.0.0.32/28 | 00010000.00000000.00000000.00100000 |
| 16.0.0.48/28 | 00010000.00000000.00000000.00110000 |

Each of the above subnets have the same netmask (e.g., they are all /28 subnets) and therefore satisfy the conditions of the first rule enumerated above. To apply the second rule (e.g., where the subnetmask is defined as netmask=netmask−1) the row of 28 series bits that are represented by a “1” in the subnet mask is reduced by one. The resultant subnet mask includes a row of 27 serial bits that are represented by a “1”. The original subnet mask and the subnet mask that satisfies the second rule are shown below:

Subnet mask: 11111111.11111111.11111111.11110000

Subnetmask−1: 11111111.11111111.11111111.11100000

The subnet addresses of the subnets that are identified as being joinable in accordance with the second rule are found by performing a bitwise “and” operation on the subnet mask and the IP address of each of the /28 subnets discussed above.

For example, a bitwise “and” operation on the mask and on the 16/28 subnet discussed above (the second one listed) would produce the following result:

subnet mask−1: 11111111.11111111.11111111.11100000

16/28 subnet: 00010000.00000000.00000000.00010000

resultant subnet: 00010000.00000000.00000000.00000000

It should be appreciated that as is generally understood, the “anding” of zero with either one or zero results in a zero whereas the “anding” of one and one results in a one (see example above).

Thus, applying the above noted netmask (e.g., subnetmask−1) to the four /28 subnets (e.g., performing a bitwise “and” operation that involves the netmask subnetmask−1 and the four /28 subnets as was demonstrated in the foregoing example) generates the following resultant /27 subnets:

| | |
|---|---|
| 16.0.0.0/27 | 00010000.00000000.00000000.00000000 |
| 16.0.0.0/27 | 00010000.00000000.00000000.00000000 |
| 16.0.0.32/27 | 00010000.00000000.00000000.00100000 |
| 16.0.0.32/27 | 00010000.00000000.00000000.00100000 |

Consequently, applying a subnet mask that is defined by the subnet mask parameter definer 201 as proposed in the example set forth above to the above noted four /28 subnets makes apparent the following: (1) the subnets 16.0.0.0/28 and 16.0.0.16/28 can be joined to form supernet 16.0.0.0/27 and (2) the subnets 16.0.0.32/28 and 16.0.0.48/28 can be joined to form supernet 16.0.0.32/27. In one embodiment, the application of the subnet mask that is defined by the subnet mask parameter definer 201 to each subnet in a list of available subnets can be carried out by the subnet comparer 205. In alternate embodiments, other components of the system for defragmenting subnet space can be employed.

In one embodiment, the subnet mask parameter definer 201 can be embodied by components that are resident at the Utility Data Center (e.g., 100 in FIG. 1), and can either be encompassed by or operate cooperatively with components of the Utility Data Center (e.g., 100 in FIG. 1). In another embodiment, the parameter definer 201 can reside at a location that is remote from the Utility Data Center (e.g., 100 in FIG. 1) and can be embodied by components that operate cooperatively with the Utility Data Center (e.g., 100 in FIG. 1).

Subnet identifier 203 identifies subnets to include in the aforementioned list of available subnets and includes subnets that are available to be allocated to resources that are a part of an adaptive infrastructure. The subnet identifier 203 monitors the subnets that are available (the subnets that are in the pool of available subnets) which can include subnets that may or may not have been used previously. Subnets that have been used previously can include subnets that were previously allocated to a resource in the adaptive infrastructure. In one embodiment, the subnet identifier 203 can be embodied by components that are resident at the Utility Data Center (e.g., 100 in FIG. 1), and can either be encompassed by or operate cooperatively with components of the Utility Data Center (e.g., 100 in FIG. 1). In another embodiment, the subnet identifier 203 can reside at a location that is remote from the Utility Data Center (e.g., 100 in FIG. 1) and can be embodied by components that operate cooperatively with the Utility Data Center (e.g., 100 in FIG. 1).

Subnet comparer 205 compares each subnet in a list of available subnets with every other subnet in the list of available subnets in order to determine if any of the subnets in the list of available subnets are joinable with other subnets in the list of available subnets. In one embodiment, subnet comparer 205 compares the subnets in the list of available subnets based on the subnet mask defined by the subnet mask parameter definer 201. In this manner, subnets in the list of available subnets that are joinable with other subnets can be determined. For example, as demonstrated in the example discussed above subnets:

| | |
|---|---|
| 16.0.0.0/28 | 00010000.00000000.00000000.00000000 |
| and | |
| 16.0.0.16/28 | 00010000.00000000.00000000.00010000 |

are joinable, and subnets:

| | |
|---|---|
| 16.0.0.32/28 | 00010000.00000000.00000000.00100000 |
| and | |
| 16.0.0.48/28 | 00010000.00000000.00000000.00110000 |

are joinable based on the rules set forth in the example above as being defined by subnet mask parameter definer 201. As discussed above, in one embodiment, the application of the subnet mask that is defined by the subnet mask parameter definer 201 to each subnet in a list of available subnets can be carried out by the subnet comparer 205. In alternate embodiments, other components of the system for defragmenting subnet space can be employed.

In one embodiment, the subnet comparer 205 can be embodied by components that are resident at the Utility Data Center (e.g., 100 in FIG. 1), and can either be encompassed by or operate cooperatively with components of the Utility Data Center (e.g., 100 in FIG. 1). In another embodiment, the subnet comparer 205 can reside at a location that is remote from the Utility Data Center (e.g., 100 in FIG. 1) and can be embodied by components that operate cooperatively with the Utility Data Center (e.g., 100 in FIG. 1).

Subnet deleter 207 deletes a subnet from the aforementioned list of available subnets if the subnet is determined to be joinable with another subnet in the list of available subnets. In one embodiment, individual subnets that are joinable together to form supernets are replaced with the supernets of the individual subnets that are joinable together (see discussion made with reference to deleted subnet replacer 209 below). In one embodiment, the subnet deleter 207 can be embodied by components that are resident at the Utility Data Center (e.g., 100 in FIG. 1), and can either be encompassed by or operate cooperatively with components of the Utility Data Center (e.g., 100 in FIG. 1). In another embodiment, the subnet deleter 207 can reside at a location that is remote from the Utility Data Center (e.g., 100 in FIG. 1) and can be embodied by components that operate cooperatively with the Utility Data Center (e.g., 100 in FIG. 1).

Deleted subnet replacer 209 replaces deleted individual subnets that are joinable together with the supernets of the individual subnets. For example, in the above noted example, the joinable subnets:

| | |
|---|---|
| 16.0.0.0/28 | 00010000.00000000.00000000.00000000 |
| and | |
| 16.0.0.16/28 | 00010000.00000000.00000000.00010000 |

can be replaced with the supernet:

| | |
|---|---|
| 16.0.0.0/27 | 00010000.00000000.00000000.00000000 |

by deleted subnet replacer 209.

In one embodiment, the deleted subnet replacer 209 can be embodied by components that are resident at the Utility Data Center (e.g., 100 in FIG. 1), and can either be encompassed by or operate cooperatively with components of the Utility Data Center (e.g., 100 in FIG. 1). In another embodiment, the deleted subnet replacer 209 can reside at a location that is remote from the Utility Data Center (e.g., 100 in FIG. 1) and can be embodied by components that operate cooperatively with the Utility Data Center (e.g., 100 in FIG. 1).

### Exemplary Operations in Method for Defragmenting Subnet Space According to One Embodiment of the Invention

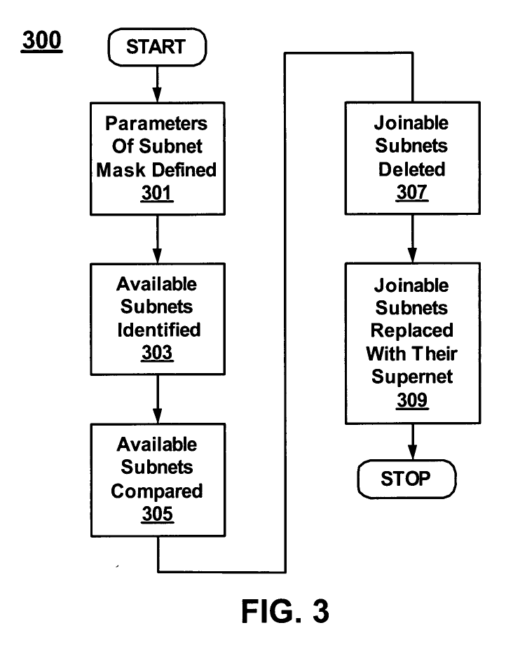

FIG. 3 shows a flowchart 300 of the steps performed in a method for defragmenting subnet space according to one embodiment of the present invention.

At step 301, parameters of a netmask that is used to determine if subnets are joinable are defined.

At step 303, subnets to include in a list of available subnets are identified that identifies subnets that are available to be allocated to resources that are a part of an adaptive infrastructure.

At step 305, each subnet in the list of available subnets is compared with every other subnet in the list of available subnets to determine if each subnet in the list of available subnets is joinable with any other subnet in the list of available subnets.

At step 307, a subnet are deleted from the list of available subnets if the subnet is determined to be joinable with another subnet in the list of available subnets.

At step 309, deleted individual subnets that are joinable together are replaced to form supernets with the supernets that comprise the deleted individual subnets that are joinable together.

According to one embodiment, the following pseudo-code can be employed to defragment the available subnet space in an adaptive infrastructure in accordance with the process discussed with reference to FIG. 3:

1. Obtain a list of all available subnets.

2. For each subnet (i), in the list.
a. Compare subnet (i) with every other subnet (j).
b. If subnet (i) and subnet (j) are joinable.
   i. Delete subnet (i)
   ii. Replace subnet (j) with the supernet of (i) and (j).
   iii. Continue at step 2 with the next available (i).

3. If there was at least one subnet joined at step 2
a. Repeat step 2

4. If there were no joins performed at step 2
a. Done

The following java code implements this pseudo-code:

```
private void defragSubnets(int type) throws SQLException{
  IPAddress[ ] subnets;
  subnets = getFreeSubnets(type);
  if(subnets == null || subnets.length == 0){
                UC.log.debug(19,“No free subnets of type: “ + type +
                ” available to defragment”);
  return;
  }
  // Put IP's into a list that we can manipulate
  ArrayList list = new ArrayList( );
  for (int i = 0; i < subnets.length; i++) {
  list.add(subnets[i]);
  }
  // We run through the list backwards because we
  // are going to be deleting items from the list
  boolean modified = true;
  while (modified == true) {
  modified = false;
  for (int i = list.size( ) − 1; i >= 0; i−−) {
    // The internal loop is so we can compare
    // the IP address at position i
    // With other IP addresses
    for (int j = i − 1; j >= 0; j−−) {
    if (joinable( (IPAddress) list.get(i), (IPAddress) list.get(j))) {
      IPAddress supernet = join( (IPAddress) list.get(i),
                  (IPAddress) list.get(j));
      // now remove the subnets represented by i and j, and replace j
              // with the newly created supernet. We can remove i
              // because we are running
      // the loops backwards,
      UC.log.debug(19, “Combining subnets: ” +
                            (IPAddress) list.get(i) +
              “ and ” + (IPAddress) list.get(j) + “ to form: ” +
            supernet);
      deleteSubnet((IPAddress) list.get(i), type);
      deleteSubnet((IPAddress) list.get(j), type);
      addSubnet(supernet, type);
      list.remove(j);
      list.add(j, supernet);
      list.remove(i);
      modified = true;
      break;
    }
    }
  }
  }
}
  private IPAddress join(IPAddress a, IPAddress b){
  //Make sure these IP's are joinable
  if( ! joinable(a,b) ){
    // We already checked that these were joinable, so we should not
    // hit this.
    return null;
  }
  IPAddress supernet = new IPAddress(a.getNetworkAddress( ),
  a.getMasklen( ) − 1);
  return new IPAddress(supernet.getNetworkAddress( ),
  a.getMasklen( ) − 1);
}
  private boolean joinable(IPAddress a, IPAddress b){
  // Subnets are joinable if
  // 1: They have the same netmask
  // 2: When 1 is subtracted from each of the netmasks,
  // the resulting network portions are equal.
  if(a.getMasklen( ) != b.getMasklen( )){
    return false;
  }
  IPAddress aa = new IPAddress(a.getIPAddress( ), a.getMasklen( ) − 1);
  IPAddress bb = new IPAddress(b.getIPAddress( ), b.getMasklen( ) − 1);
  if ( aa.getNetworkAddress( ).equals(bb.getNetworkAddress( )) ){
    return true;
  }else{
    return false;
  }
}
```

Methods and systems for defragmenting subnet space within an adaptive infrastructure are disclosed. A method includes defining parameters of a netmask that is used to determine if subnets are joinable, identifying subnets to include in a list of available subnets that identifies subnets that are available to be allocated to resources that are a part of an adaptive infrastructure and comparing each subnet in the list of available subnets with every other subnet in the list of available subnets to determine if each subnet in the list of available subnets is joinable with any other subnet in the list of available subnets. The method further includes deleting a subnet from the list of available subnets if the subnet is determined to be joinable with another subnet in the list of available subnets, and replacing deleted individual subnets that are joinable together with supernets of the deleted individual subnets that are joinable together.

Advantages provided by exemplary embodiments include the provision of automation to the problem of defragmenting of subnet space. Previously, when subnet space became fragmented, an operator that was experienced in the rules for joining subnets would perform the defragmentation. It should be appreciated that this process was both error prone and time consuming. Exemplary embodiments provide a process that is both efficient and not prone to error.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for defragmenting subnet space within an adaptive infrastructure, said method comprising:
defining parameters of a netmask that is used to determine if subnets are joinable;
accessing subnets to include in a list of available subnets that identifies subnets that are available to be allocated to resources that are a part of an adaptive infrastructure;
comparing each subnet in said list of available subnets with every other subnet in said list of available subnets to determine if said each subnet in said list of available subnets is joinable with any other subnet in said list of available subnets; and
updating said list to replace joinable subnets with a supernet comprising said joinable subnets.

2. The method of claim 1 wherein said updating comprises:
deleting a subnet from said list of available subnets if said subnet is determined to be joinable with another subnet in said list of available subnets; and
replacing deleted individual subnets that are joinable together with supernets of said deleted individual subnets that are joinable together.

3. The method of claim 1 wherein said defining parameters of said netmask comprises determining the bitwise length of said netmask.

4. The method of claim 1 wherein a subnet is joinable with another subnet if said subnet is adjacent to said another subnet.

5. The method of claim 1 wherein said netmask is applied to determine if a subnet is adjacent to another subnet.

6. The method of claim 1 wherein said identifying subnets to include in a list of available subnets comprises identifying IP addresses that correspond to available adaptive infrastructure resources.

7. The method of claim 1 wherein said adaptive infrastructure is a Utility Data Center (UDC).

8. The method of claim 1 wherein said adaptive infrastructure resources are selected from a group that consists of data storage, computers, IP addresses, servers and applications.

9. The method of claim 1 wherein said list of available subnets comprises subnets that were previously unavailable for use.

10. The method of claim 1 wherein said adaptive infrastructure comprises a management application that logically assigns subnets to different services.

11. The method of claim 1 wherein said method for defragmenting subnet space within an adaptive infrastructure further comprises:
automatically allocating and deploying resources in response to a request.

12. A system for defragmenting subnet space within an adaptive infrastructure, said system comprising:
a parameter definer for defining parameters of a netmask that is used to determine if subnets are joinable;
a subnet identifier for identifying subnets to include in a list of available subnets that identifies subnets that are available to be allocated to resources that are a part of an adaptive infrastructure;
a subnet comparer for comparing each subnet in said list of available subnets with every other subnet in said list of available subnets to determine if said each subnet in said list of available subnets is joinable with any other subnet in said list of available subnets;
a subnet deleter for deleting a subnet from said list of available subnets if said subnet is determined to be joinable with another subnet in said list of available subnets;
a subnet replacer for replacing deleted individual subnets that are joinable together with supernets of said deleted individual subnets that are joinable together.

13. The system of claim 12 wherein said subnet updater comprises:
a subnet deleter for deleting a subnet from said list of available subnets if said subnet is determined to be joinable with another subnet in said list of available subnets;
a subnet replacer for replacing deleted individual subnets that are joinable together with supernets of said deleted individual subnets that are joinable together.

14. The system of claim 12 wherein said parameter definer defines parameters of said netmask by determining the bitwise length of said netmask.

15. The system of claim 12 wherein said subnet comparer determines if a subnet is joinable with another subnet by determining if said subnet is adjacent to said another subnet.

16. The system of claim 12 wherein said subnet comparer applies a netmask to determine if a subnet is adjacent to another subnet.

17. The system of claim 12 wherein said subnet identifier identifies subnets to include in a list of available subnets by identifying IP addresses that correspond to available adaptive infrastructure resources.

18. The system of claim 12 wherein said adaptive infrastructure is a (UDC) Utility Data Center.

19. The system of claim 12 wherein said adaptive infrastructure resources are selected from a group that includes data storage, computers, IP addresses, servers and applications.

20. The system of claim 12 wherein said list of available subnets comprises subnets that were previously unavailable for use.

21. The system of claim 12 wherein said adaptive infrastructure comprises a management application that logically assigns subnets to different services as needed.

22. The system of claim 12 wherein said system for defragmenting subnet space within an adaptive infrastructure automatically allocates and deploys resources in response to a request.

23. A computer useable medium having computer useable code embodied therein causing a computer to perform operations comprising:
establishing parameters of a netmask that is used to determine if subnets are joinable;
identifying subnets to include in a list of available subnets that identifies subnets that are available to be allocated to resources that are a part of an adaptive infrastructure;
comparing each subnet in said list of available subnets with every other subnet in said list of available subnets to determine if said each subnet in said list of available subnets is joinable with any other subnet in said list of available subnets; and
updating said list to replace joinable subnets with a supernet comprising said joinable subnets.

24. The medium of claim 23 wherein said updating comprises:
deleting a subnet from said list of available subnets if said subnet is determined to be joinable with another subnet in said list of available subnets; and
replacing deleted individual subnets that are joinable together with supernets of said deleted individual subnets that are joinable together.

25. The medium of claim 23 wherein said establishing parameters of said netmask comprises determining the bitwise length of said netmask.

26. The medium of claim 23 wherein a subnet is joinable with another subnet if said subnet is adjacent to said another subnet.

27. The medium of claim 23 wherein said netmask is applied to determine if a subnet is adjacent to another subnet.

28. The medium of claim 23 wherein said identifying subnets to include in a list of available subnets comprises identifyng IP addresses that correspond to available adaptive infrastructure resources.

29. The medium of claim 23 wherein said adaptive infrastructure is a Utility Data Center (UDC).

30. The medium of claim 23 wherein said adaptive infrastructure resources are selected from a group that includes data storage, computers, IP addresses, servers and applications.

31. The medium of claim 23 wherein said list of available subnets comprises subnets that were previously unavailable for use.

32. The medium of claim 23 wherein said adaptive infrastructure comprises a management application that logically assigns subnets to different services as needed.

33. The medium of claim 23 wherein said method for defragmenting subnet space within an adaptive infrastructure further comprises:
automatically allocating and deploying resources in response to a request.
